(19) United States
(12) Patent Application Publication
(10) Pub. No.: US 2010/0115836 A1
(43) Pub. Date: May 13, 2010

(54) BIODEGRADABLE AGRICULTURAL GROWTH MANAGEMENT TOOLS

(76) Inventor: Brandon J. Julian, Park City, UT (US)

Correspondence Address: THORPE NORTH & WESTERN, LLP., P.O. Box 1219, SANDY, UT, 84091-1219, US

(21) Appl. No.: 12/618,204

(22) Filed: Nov. 13, 2009

Related U.S. Application Data
(60) Provisional application No. 61/114,197, filed on Nov. 13, 2008.
(60) Provisional application No. 61/227,709, filed on Jul. 22, 2009.

(51) Int. Cl. A01G 9/02; C08L 75/04; C08L 3/04; C08L 33/00; C08L 1/00; A01G 1/00; A01G 17/00; G09F 11/00

(52) U.S. Cl. 47/65.7; 523/124; 523/128; 135/118; 47/84; 47/48.5; 47/65.5; 47/44; 47/72; 47/67; 47/66.6; 40/1

(57) ABSTRACT

An agricultural growth management tool can include a biodegradable polymer body having a synthetic polymer and an optional biodegradability enhancement additive. The biodegradability enhancement additive can include a microbial attractant. The biodegradable polymer body can be configured as a plant stake, branch tag, blister pack, plantable container, agrifilm, drip tubing, drip tubing connectors, drip tubing accessories, market trays, plug and propagation trays, flats and inserts, transfer pots, transfer trays, landscape ribbon, landscape twine/rope, landscaping bags, pot wraps, floral wraps, hanging basket assemblies, greenhouse films/sheets or the like. The synthetic polymer can be a biodegradable polymer, inherently non-biodegradable polymer, or a combination of the two.

### RELATED APPLICATIONS

This application claims priority to U.S. Provisional Application No. 61/114,197, filed Nov. 13, 2008 and U.S. Provisional Application No. 61/227,709, filed Jul. 22, 2009, and which are each incorporated herein by reference.

### BACKGROUND

In the agricultural and horticultural industries, a wide variety of plastic materials are used in a wide variety of products at all levels of distribution including growers, distributors, retailers, and consumers. Such materials account for a very large volume of discarded plastics. Examples of such materials include tags, pots, trays, baskets, drip tube systems, weed barriers, greenhouse sheets, or the like. In each of these cases, the utility of conventional devices often comes to an end once the associated plants have been sold or sufficiently matured. This practice can generate considerable waste, particularly when plants are used in large quantities, such as the establishment of a new home garden, or in professional landscaping projects. In these cases, the materials must be collected and disposed of, and often end up in local landfills. Durable synthetic materials may linger as solid waste for many years and contribute to overflowing landfills and other negative impacts on the environment. Despite recent modest increases in recycling efforts, many of these materials end up in landfills or are otherwise not recycled.

### SUMMARY

An agricultural growth management tool can include a biodegradable polymer body having a synthetic polymer and a biodegradability enhancement additive. The biodegradability enhancement additive can include a microbial attractant. The agricultural growth management tool can be configured for a variety of agricultural uses such as identification, containment, and control of growth conditions, for example. Accordingly, the biodegradable polymer body can be configured as a plant stake, branch tag, blister pack, plantable container, weed barrier sheet, drip tubing, drip tubing connectors, drip tubing accessories, market trays, plug and propagation trays, flats and inserts, transfer pots, transfer trays, landscape ribbon, landscape twine/rope, landscaping bags, pot wraps, floral wraps, hanging basket assemblies, greenhouse films/sheets or the like.

The synthetic polymer can include biodegradable polymer, inherently non-biodegradable polymer, or a combination of the two. Regardless of whether the synthetic polymer is inherently biodegradable or not, the polymer body can include the microbial attractant.

In one specific alternative, an agricultural growth management tool can be provided in which the biodegradable material does not require the microbial attractant. For example, tubing and/or associated connections can be formed of biodegradable materials which can be left in place after use. In this manner, the drip tubing system can ultimately biodegrade while also having a useful service life of at least several months. Other such tools can include landscape ribbons, landscape twine, greenhouse sheets, weed barriers, and the like.

The more important features have been outlined, rather broadly, so that the detailed description thereof that follows may be better understood, and so that the present contribution to the art may be better appreciated. Other features will become clearer from the following detailed description, taken with the accompanying claims, or may be learned by the practice of the invention.

### DETAILED DESCRIPTION OF EXAMPLE EMBODIMENTS

Reference will now be made to exemplary embodiments, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

In describing various embodiments, the following terminology will be used.

The singular forms “a,” “an,” and “the” include plural referents unless the context clearly dictates otherwise. Thus, for example, reference to “an active substance” includes reference to one or more of such substances.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Durations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. This same principle applies to ranges reciting only one numerical value and should apply regardless of the breadth of the range or the characteristics being described.

As used herein, “biodegradable” refers to a material which can be at least substantially broken down into smaller chemical moieties by action of enzymes, water, oxygen, or other materials present in soil. Biodegradable can include complete mineralization although this is not always required. Biodegradable can include both aerobic and/or anaerobic digestion, and may include oxygen degradation and/or light exposure degradation, e.g. forming CO₂ and H₂O. Preferably, degradation products are non-toxic and non-hazardous in the environment in which they are left. Biodegradation can often be characterized by breakdown of organic molecules into biogas (e.g. methane and carbon dioxide) and humus (e.g. a biologically stable biomass).

As used herein, “inherently non-biodegradable polymer” refers to a polymer that does not substantially biodegrade under ASTM D 5511 conditions as prepared. More particularly, such inherently non-biodegradable polymers do not biodegrade without an additional component or processing treatment.

As used herein, the term “soil” refers to any material in which a plant may be planted on a long-term basis, is capable of retaining water, and that provides the plant with benefits typically associated with planting, including physical support, nourishment, and root protection. As such, soil includes all natural substrates such as sand, peat, clay, loam, compost and mixtures thereof.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill. Further, unless otherwise stated, the term “about” shall expressly include “exactly,” consistent with the discussion above regarding ranges and numerical data.

An agricultural growth management tool can include a biodegradable polymer body having a synthetic polymer and a biodegradability enhancement additive. The biodegradability enhancement additive can include a microbial attractant. The agricultural growth management tool can be configured for a variety of agricultural uses such as identification, containment, and control of growth conditions. Accordingly, the biodegradable polymer body can be configured as a plant stake, branch tag, blister pack, plantable pot (e.g. 1 cup-95 gallon), weed barrier sheet, drip tubing, market trays, plug and propagation trays, flats and inserts, transfer pots, transfer trays, landscape ribbon, landscape twine/rope, landscaping bags (used to collect leaves, debris, clippings, etc), pot wraps, floral wraps, hanging basket assemblies, and greenhouse films/sheets. In one specific aspect, the biodegradable polymer body is a plant stake or branch tag such as those which provide visible indicia for identification and communication of information relevant to the associated plant. These particular tools are described in more detail below. A blister pack (e.g. pony pack) can be formed of a thin film molded into multiple compartments. Most often these packs can include six or eight arrayed containers which are connected together. Such containers may be detachable from each other. Individualized plantable containers can also be useful when the biodegradable polymer body is intended to be left in place upon planting in the ground. Optional detachable sections and/or perforated lines can be provided to allow openings to be formed in the container walls and to accelerate access of roots to soil outside the planted container. This can be desirable in order to compensate for the relatively slower degradation of the container walls compared to establishment of the root system in the surrounding soil. Weed barrier sheets can also be a desirable configuration for the biodegradable polymer bodies. For example, a large area film or sheet of material can be provided which prevents or reduces weed growth. The film can be alternatively fibrous or porous to allow flow of moisture across the film while reducing access of weed roots into underlying soil.

In yet another aspect, the biodegradable polymer body can be configured as a drip tubing and/or associated connectors or accessories (e.g. coupling, t-coupling, valves, caps, emitters, air vents, etc.), agrifilm (e.g. weed barrier sheet, agrimulch, and the like), landscape ribbon, landscape twine/rope, pot wraps, floral wraps, hanging basket assemblies, or greenhouse sheets. The biodegradable polymer body can biodegrade substantially completely within about 8 years according to ASTM D 5511 biodegradation test under anaerobic conditions, while also retaining fluid delivery functionality for at least 3 months and in one aspect at least 4 months, and up to about 12 months and in one aspect up to about 6 months. In this embodiment, the microbial additive is optional as long as biodegradability is maintained as outlined within about 8 years.

Such drip tubing systems can be designed for temporary installations where such irrigation is needed only for a matter of a few months. Thus, rather than pulling up such systems at a season end, the materials can be left in place and/or tilled into the soil. When pulled from an installation, conventional drip tubing exhibits numerous leaks and/or other damage which prevents economical reuse. As such, it is typically discarded. Providing biodegradable drip tubing which is left in place after its serviceable life can eliminate the cost of removing the system and avoid contributing to landfills. Depending on the particular composition of the drip tubing and timing of plowing, biodegradation may only be partial by the time plowing of the area is needed. Therefore, the drip tubing system can optionally be removed and discarded. Advantageously, the discarded drip system can quickly complete biodegradation in the landfill. Optionally, portions of the drip system can be biodegradable (e.g. tubing) while connectors, valves, emitters and the like can be formed of conventional non-biodegradable plastics and recovered for reuse.

Similarly, agrifilm, landscape ribbon, landscape twine/rope, pot wraps, floral wraps, hanging basket assemblies, or greenhouse sheets can be installed in temporary applications. For example, farming and/or nursery starts can have a limited service life of several weeks to a single season. As such, weed barrier sheets used in these applications can be plowed under or discarded without concern for long term landfill occupation. Each of the planar products (e.g. agrifilm, greenhouse sheet, ribbon, pot wraps, and floral wraps) can be provided as a non-woven film, woven material, geotextile, or other configuration. For example, the weed barrier sheets and/or greenhouse sheets can be woven or non-woven polymer. Landscape ribbon and twine or rope is similarly often used for temporarily tying or restraining limbs or other members together. The typical service life of such materials can be limited to several months to a few years. For example, landscape ribbon may be used to stake saplings or new shoots until they can maintain the desired shape on their own. Pot wraps and floral wraps can similarly have a short useful life. In some cases, certain products can have a longer desire service life. In such cases, the material can merely be kept substantially free of microbially active environments (e.g. landfill, soiled, etc.) For example, a pot wrap kept free of dirt and soiling can be maintained indefinitely without biodegradation. Similarly, hanging basket assemblies and/or greenhouse sheets can be kept in use for several years before being replaced. One advantage of at least some of the biodegradable materials disclosed herein (especially those involving the use of an additive to inherently non-biodegradable polymers) is that biodegradation only occurs under certain environmental conditions. The inherently biodegradable polymers may biodegrade more quickly but such processes can be delayed when the material is not exposed to landfill or other microbially active environments.

In one alternative, biodegradation of the agricultural tool or system can be accelerated by exposing the system to a dosage of an optimized microbial population. This can be provided in a solid or solution form which is sprayed over the system and/or infused or flushed through the system. Non-limiting examples of microbes which can be used as part of the formulation or in these supplemental dosage forms can include actinobacteria, Rhodococcus and B. borstelensis, psychrophiles, mesophiles, thermophiles, actinomycetes, saprophytes, absidia, acremonium, alternaria, amerospore, arthrinium, ascospore, aspergillus, aspergillus caesiellus, aspergillus candidus, aspergillus carneus, aspergillus clavatus, aspergillus deflectus, aspergillus flavus, aspergillus fumigatus, aspergillus glaucus, aspergillus nidulans, aspergillus ochraceus, aspergillus oryzae, aspergillus parasiticus, aspergillus penicilloides, aspergillus restrictus, aspergillus sydowi, aspergillus terreus, aspergillus ustus, aspergillus versicolor, aspergillus/penicillium-type, aureobasidium, basidiomycetes, basidiospore, bipolaris, blastomyces, botrytis, candida, cephalosporium, chaetomium, cladosporium, cladosporium fulvum, cladosporium herbarum, cladosporium macrocarpum, cladosporium sphaerospermum, conidia, conidium, conidobolus, cryptococcus neoformans, cryptostroma corticale, cunninghamella, curvularia, dreschlera, epicoccum, epidermophyton, fungus, fusarium, fusarium solani, geotrichum, gliocladium, helicomyces, helminthosporium, histoplasma, humicula, hyaline mycelia, memnoniella, microsporum, mold, monilia, mucor, mycelium, myxomycetes, nigrospora, oidium, paecilomyces, papulospora, penicillium, periconia, perithecium, peronospora, phaeohyphomycosis, phoma, pithomyces, rhizomucor, rhizopus, rhodotorula, rusts, saccharomyces, scopulariopsis, sepedonium, serpula lacrymans, smuts, spegazzinia, spore, sporoschisma, sporothrix, sporotrichum, stachybotrys, stemphylium, syncephalastrum, thermononespore fusca DSM43793, torula, trichocladium, trichoderma, trichophyton, trichothecium, tritirachium, ulocladium, verticillium, wallemia, yeast, and mixtures of these microbes.

In one specific aspect, the synthetic polymer can be an inherently non-biodegradable polymer. Non-limiting examples of inherently non-biodegradable polymers can include polyethylene, polypropylene, polystyrene, polyurethane, polycarbonate, polyvinyl chloride, polyacrylates, copolymers thereof, and combinations thereof. In one aspect, the inherently non-biodegradable polymer is polystyrene. In another aspect, the inherently non-biodegradable polymer is polyethylene such as, but not limited to, low density polyethylene and high density polyethylene. When used alone, the presence of an additive can be required in order to make the overall polymer body biodegradable.

Alternatively, at least a portion of the synthetic polymer can be a biodegradable polymer. In one aspect, the entire biodegradable polymer body is a biodegradable polymer. However, portions of the tool can also be formed of inherently non-biodegradable polymer as long as the overall tool is maintained as a biodegradable by addition of a suitable additive. In one aspect, the synthetic polymer is a biodegradable polymer such as, but not limited to, biodegradable polyethylene, biodegradable polyanhydride, biodegradable polyester, cellulose derivatives, starch-based polymers, lignin, chitin, copolymers thereof, and combinations thereof.

Regardless of whether the synthetic polymer is inherently biodegradable or not, the polymer body can include the microbial attractant. Such materials can act to draw microbes (e.g. bacteria, fungus, etc.) from the surrounding soil in higher concentrations sufficient to increase attack on and degradation of the polymer. Examples of suitable microbial attractants can include sugars, starches, a furanone, and combinations thereof. Optimal microbial attractants can vary for particular microbial environments and can include any material which acts to increase microbial growth over a composition without the attractant. For example, certain microbes may be either repelled or attracted by certain sugars or furanones. One example is that of C. violaceum which is attracted by 3,5-dimethylyentenyl dihydro-2(3H) furanone while E. Coli and Salmonella is attracted by L and D-sugars. Non-limiting examples of suitable sugars can include monosaccharides and disaccharides such as glucose, sucrose, lactose, galactose, ribose, etc. Other low molecular weight polysaccharides including simple starches may also be included.

The biodegradability enhancement additive can optionally further include one or more of a swelling agent, a microbe population, a carrier resin, a colorant, and a filler. In one aspect, the biodegradability enhancement additive further includes an organic carboxylic acid such as at least one of glutaric acid and palmitic acid. Additional alternatives and guidelines for suitable options in choice of the biodegradability enhancement additive can be found in U.S. Patent Application Publication No. 2008/0103232 which is incorporated herein by reference in its entirety (commercially available as EcoPure® from Bio-Tec Environmental). Other non-limiting examples of suitable biodegradability enhancement additives can include Nor-X Intelligent additives such as Renatura®, microbiodegradable plastics such as Earth Nurture Additive (available from BioGreen Products), oxobiodegradation additives such as PDQ, PDQ-H and BDA (available from Willow Ridge Plastics), polystarch additives (available from Willow Ridge Plastics), and the like.

Although optimal compositions can vary depending on the application, desired shelf-life, desired service life, and the like, the biodegradability enhancement additive can comprise from about 0.5 wt % to about 5 wt % of the biodegradable polymer body. In some aspects, the biodegradability enhancement additive is sufficient to cause at least 5% biodegradation within 15 days according to ASTM D 5511 biodegradation test under anaerobic conditions. In soil conditions, the microbial populations can grow under either or both anaerobic and aerobic conditions. However, in most cases the tools can be exposed to buried conditions which result in substantially reduced sunlight exposure and limited aerobic circulation. In one specific embodiment, the biodegradability enhancement additive is sufficient to cause at least 10% biodegradation within 3 months according to ASTM D 5511 biodegradation test under anaerobic conditions. In many cases, it is ultimately desirable for the tool to be rendered substantially integrated with the surrounding soil within a reasonable period of time. Accordingly, in another aspect, the biodegradability enhancement additive is sufficient to cause substantially complete biodegradation (e.g. greater than 90%) within 8 years according to ASTM D 5511 biodegradation test under anaerobic conditions.

When the agricultural growth management tool is a plant identification device, it can include a tag and an active substance associated with the tag. The tag can include indicia to identify a plant with which the device is associated. The tag can be configured to be inserted into the soil near a plant to be identified. The active substance can be chosen and associated with the tag so as to disperse into the soil and act on the soil or the plant. Active substances can include fertilizers, plant food, biocides or other active materials designed for a specific plant and growth environment. In addition, a portion or all of the device can be formed of biodegradable materials so as to eliminate the need for disposal of the device after the identification function is achieved while also providing predetermined salutary affects on the plant and/or surrounding soil.

A device for providing information about a plant can comprise an identification tag configured to be inserted in the soil in which the plant or seeds have been planted. Various shapes are employed in adapting tags and similar items for insertion into such substrates, and such shapes as are known in the art may be used. Generally, an insertable tag includes a tag body and an insertion leg integral to said body. Adaptations for insertion often include tapering the insertion leg so as to form a substantially pointed tip. In other aspects insertion is facilitated by giving this portion a flat cross-section, though alternate cross-sections (e.g. curved, circular, oval, or diamond-shaped) may be used to lend strength for insertion into firm substrates. Optional longitudinal creases, bends or strips can be added to increase resistance to bending.

According to the general embodiment, the plant identification device also includes indicia printed on the tag that identify a plant with which the tag is associated. As used herein with reference to such indicia, the term “identify” or “identification” particularly includes providing information such as a common and/or scientific name by which the plant is known. However, it may also include providing other information used to categorize plants, such as general characteristics (annual, perennial, hardy, etc.), general needs (e.g. watering frequency, sun/shade exposure), and recommended terrain for planting. In another aspect of the present invention, the indicia may include additional information such as instructions for planting and care, e.g. planting depth, soil composition, etc. In another aspect, the indicia may include pictorial information about the plant, such as diagrams, drawings, or photographs. In another aspect, the indicia may include information in proper use of the device such as instructions to embed the tag into the soil.

The plant identification device may also include an active substance associated with the tag, wherein the active substance is capable of being dispersed into the soil. Generally, the active substance is one that is capable of acting on the soil and/or on the plant. The active substance may be any agent known in the art as being useful in horticulture, including fertilizers, antibiotics, fungicides, pesticides such as rodenticides and insecticides, selective herbicides, and soil fumigants and other soil conditioners, including combinations of these materials. When multiple active substances are used, such can be mixed or spatially segregated. In a particular embodiment, the active substance is a fertilizer. In this embodiment, the device serves at least two purposes while it is in place: (a) promoting growth of the plant, and (b) providing information about the plant to a concerned person.

Non-limiting examples of suitable fertilizers can include various NPK ratio fertilizer (e.g. adjusted for plant type, starter, winterizers, etc.) which can include mixtures of salts, for example, epsom salts, ammonium nitrate, sodium nitrate, calcium nitrate, potassium nitrate, ammonium sulfate, ferrous sulfate, potassium sulfate, urea, and the like, plant food, organic fertilizers such as green sand, blood meal, bone meal, cottonseed meal, fish emulsion, seaweed extract, wood ash, super phosphate, other sources of macronutrients, secondary nutrients, and/or micronutrients.

Pre or post-emergent selective herbicides, i.e. weed killers, can be optionally integrated with the fertilizer or other active substances. Insecticides can include ovicides and larvacides, can include, but are not limited to, organochloro insecticides, organophosphates, pyrethroids, neonicotinoids, carbamates, phenothiazines, dessicant insecticides, growth regulators, biological insecticides, and the like. In one specific embodiment, the insecticide can be a biological insecticide.

The active substance can be associated with the tag in a number of ways. For example, the active substance can typically be presented in granular form which can be coated onto the tag or pressed into a desired shape, although gel or liquid formulations can be used with an appropriate delivery vehicle to prevent premature dispersion. More specifically, the active substance can be present in any form that will allow for a reliable association with the tag when the tag is not in soil, while permitting appropriate dispersion into the soil when the tag is in place.

In one particular embodiment, granular forms of the active substance can be formulated as a coating which can be applied to the tag. For example, a water soluble carrier can be used as a matrix to hold the grains. Non-limiting examples of suitable carrier can include cellulose variants (e.g. hydroxymethylcellulose, methylcellulose, etc.), collagen, corn meal, gelatin, polycaprolactones, polyesters, phosphazenes, phosphoesters, polyanhydrides, combinations of these materials with one another or with other materials. The coating material can further include additives such as colorants, pH modifiers, polymers, or the like in order to adjust degradation times and/or other desired properties.

In an alternate embodiment, the active substance can be in a solid formulation that is attached to the tag. In one aspect of this embodiment, the active substance is compressed into a solid form such as a pellet, rod or stake. Upon insertion and exposure to soil and/or water the solid form disintegrates to release the substance into the soil. In a more specific aspect, the solid form may be designed to control the rate of release of the substance, so that it occurs over a desired period of time. For example, slow-release fertilizers such as water-insoluble nitrogen can be sulfur coated or polymer coated.

Such solid formulations can be attached to the tag using any suitable means. For example, a glue such as fugitive glue, pressure sensitive adhesive, polyurethane hot melt, dextrin adhesive, animal glues, casein glues, and the like. In one specific embodiment, the glue can be a biodegradable glue. In another embodiment, biodegradable glue is used to attach a solid formulation of the active substance directly to the tag, or to attach a separate container of active substance to the tag.

The solid formulation can be oriented so as to be in contact with soil when the tag is in use, e.g. placed near or at the tip such that a portion of the solid formulation is in the soil. Alternatively, the solid formulation can be oriented in an upper portion of the tag such that the active substance only contacts the soil after planting or potting of the plant when the tag is buried in the soil.

In another alternate embodiment, the active substance can be incorporated into the material or body of the tag as part of a manufacturing process. In this manner, the active substance can be dispersed within the completed tag. In this embodiment, the tag as a whole or a portion thereof may serve as a controlled release form. In a particular example, the tag may be constructed from porous material, where the pores contain a releasable substance. In still another embodiment, the tag includes a reservoir in which the active substance is contained. For example, the active substance may be included in the tag in a microencapsulated form, where the encapsulation is configured to break down under the conditions present in the soil and thereby release the substance into the soil. Microencapsulation can be readily achieved using any suitable technique such as, but not limited to, pan coating, fluid bed coating, air-suspension, rotary disk atomization, centrifugal extrusion (e.g. liquid active substances), nozzle coextrusion, spray drying, matrix encapsulation, nanoencapsulation, interfacial polymerization, in situ polymerization, matrix polymerization, or the like. Shell materials for encapsulation can vary but may include materials such as proteins, starches, fats, waxes, polymers, or other polysaccharides. Alternatively, the reservoir can be a pouch which is attached to the tag and which can dispense the active substance upon breach of the pouch lining. Breach can be accomplished by physically breaking or by decomposition (e.g. of a paper or other biodegradable film).

Conventional plant tags are typically discarded once their display function is no longer needed. A valuable benefit can be realized by reducing the waste resulting from the use of such tags by the devices disclosed herein. Accordingly, in a particular embodiment of the plant identification device, the tag may be constructed from biodegradable materials. In some cases, the plant identification device can consist essentially of biodegradable materials. This type of tag can optionally be made of wheat, corn or PLA type organic plastics to speed up the delivery of the active additives, i.e. fertilizer. In reference to the devices and materials disclosed herein, “biodegradation” or “degradation” is the breakdown of organic substances over time, particularly in a natural environment. Particularly, this breakdown may be achieved by reaction of the material with naturally occurring agents, or by the enzymatic digestive processes of microbes in the environment. Biodegradation as generally understood, results in the substantial integration of the original materials into the environment with minimal unreacted residue, e.g. original non-degraded material.

With this embodiment, the tags may be allowed to naturally degrade into the soil rather than discarding them. For example, the tag may be simply left in place in the soil in which it has been inserted, where the tag eventually degrades due to continued exposure to the soil and the elements. This mode of use can arise in situations where plants have been planted in a desired growing spot in a garden, and the tags are placed next to the appropriate plants to temporarily provide an end-user (e.g. a gardener) with identification and care instructions. The inidica can include information such as, but not limited to, plant common name, scientific name, care guidelines, recommended growing conditions, planting depth, and the like. After a period of time, growth of the plants and/or familiarity with the layout may make identification cues unnecessary. Such an approach can be facilitated by choosing materials that remain intact for a sufficient period of time before degrading to the point of unreadability.

Another use that can benefit from biodegradable tags is in the commercial landscaping and horticultural industries. Identification devices may be used by a commercial provider to label each plant in its temporary container. The end-user (e.g. a landscaper) who obtains the plants from the provider then typically removes them from their containers and replants them in locations indicated by the project layout. Rather than discarding the identification devices upon replanting, the end-user may simply drop each plant's tag in the corresponding planting hole before placing the plant therein. Over time the tag will degrade, eliminating waste that would otherwise require disposal. In addition, the active substance associated with the tag would be allowed to continue to act on the soil and/or plant. An additional benefit is realized in that attaching the active substance to the tag provides an incentive for the end-user to use the tag in this way rather than discarding it.

The identification tag may be made from any known biodegradable material, particularly materials that are known to substantially degrade when buried in soil. It will be understood by those having skill in the art that different materials will exhibit different degradation in a given kind of soil and under given soil conditions (moisture level, pH, biotic content, temperature, etc.) As such, materials for the tag may be chosen based on the kind of plant with which it will be associated, and the growing conditions recommended for such plants. In a particular embodiment, the biodegradable materials used include biodegradable polymers. Such polymers include polyethylenes, polyanhydrides, polyesters, cellulose derivatives, starch-based polymers, lignin, chitin, polylactic acid resins, and the like. Other biodegradable plastics can include those based on vegetable oil, pea starch, microbiota, thermoplastic starch, sugar, corn starch, and the like. The biodegradable plastic can optionally include colorants, plasticizers, etc. Biodegradation in the plant identification device may also be enhanced by using biodegradable material for other elements of the device. In a particular embodiment, indicia printed on the tag are printed using biodegradable inks Non-limiting examples of suitable biodegradable inks include Biotech color (available from Dainichiseika), polyhydroxyalkanoate ink, alginate ink, gravure inks from Toyo Ink, and the like.

Materials for use in manufacturing the device can be chosen based on a desired rate or duration of degradation. Accordingly, the biodegradable tag is designed to substantially degrade over a period of time after being placed in soil. In a particular embodiment, substantial degradation occurs in less than about 60 months. In more specific aspect, substantial degradation occurs within from about 3 months to about 48 months. For certain uses, it may be beneficial if initiation of biodegradation is delayed for a period of time. This provides a sufficient shelf life for a device that has been installed with a plant, so that degradation does not interfere with the tag's identification function until after that function is no longer needed. In addition, it may be useful to choose materials for the tags so that the tags do not degrade appreciably before use. For example, the device may need to be stored for up to 120 days before being placed in soil. To this end, an embodiment a coating may be applied to the tag to retard degradation and provide a sufficient pre-use shelf life.

The biodegradation process and time frame may also be chosen with regard to the delivery of active substance into the soil. For example, materials may be selected that delay degradation until the active substance is substantially dispersed. Alternatively, release of active substance may be linked to biodegradation of the tag. One example of this approach is found in embodiments in which the active substance is dispersed within the tag. In another embodiment using this approach, the tag may include a hollow chamber (e.g. an ampoule) in which the active substance can be enclosed. This space may be defined or bounded by material that affects release of the substance. In one aspect, the space may be permeable to the substance. In another aspect, the space is part of the tag and therefore also constructed of biodegradable material, so that the active substance is released into the soil as the tag degrades.

Methods for making plant identification devices can comprise forming a tag as described above, printing indicia upon the tag, and attaching an active substance to the tag. In a particular aspect, the tag is configured to facilitate insertion into soil. Plant identification tags may be made by processes known in the art. In particular, polymers may be pressed into sheets by any number of processes such as, but not limited to, roll forming, film coating, roll extrusion, and the like. Tags of a desired shape can be formed, for example, by die cutting, stamping, or the like. The indicia may be applied to the tags by various known printing processes such as, but not limited to, screen printing, offset printing, and ink jet printing. These printing approaches can be applied to pre-cut individual tags or to whole sheets before cutting.

Processes for making tags may be varied to accommodate the above-described modes of associating active substance with the tags. Such modifications may involve additional steps for adhering solid substances or containers to the tags after cutting and printing. Alternatively, additional steps may be added to the process of forming the tags, particularly in embodiments in which an active substance is contained within some part of the tag itself. In one example, a multi-ply design is employed, where the tag is formed by adhering at least two polymer sheets. A space for active substance may be provided by opposing concavities in each sheet that form a hollow chamber when the sheets are joined.

Thus, devices and methods for plant identification in which active substances are associated with identification tags are also disclosed. Among the benefits provided are biodegradability combined with additional functions such as a fertilizer or other active substance that promote environmentally friendly use. Furthermore, the various aspects of each embodiment can be applied to other embodiments unless clearly incompatible. For example, the fertilizer attachment materials and mechanisms can be equally applied to any of the tools beyond just the plant stakes and tags, e.g. pots, drip tubing, etc.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. An agricultural growth management tool, comprising a biodegradable polymer body including a synthetic polymer and a biodegradability enhancement additive, said additive including a microbial attractant.

2. The tool of claim 1, wherein the biodegradable polymer body is selected from the group consisting of plant stake, branch tag, blister pack, plantable container, agrifilm, drip tubing, drip tubing connectors, drip tubing accessories, market trays, plug and propagation trays, flats and inserts, transfer pots, transfer trays, landscape ribbon, landscape twine/rope, landscaping bags, pot wraps, floral wraps, hanging basket assemblies, and greenhouse films/sheets.

3. The tool of claim 2, wherein the biodegradable polymer body is a plant stake or branch tag.

4. The tool of claim 2, wherein the biodegradable polymer body is a drip tubing.

5. The tool of claim 1, wherein the synthetic polymer is an inherently non-biodegradable polymer.

6. The tool of claim 5, wherein the inherently non-biodegradable polymer is selected from the group consisting of polyethylene, polypropylene, polystyrene, polyurethane, polycarbonate, polyvinyl chloride, polyacrylates, wheat plastics, corn plastics, PLA plastics, copolymers thereof, and combinations thereof.

7. The tool of claim 6, wherein the inherently non-biodegradable polymer is polystyrene or polyethylene.

8. The tool of claim 1, wherein the synthetic polymer is a biodegradable polymer selected from the group consisting of biodegradable polyethylene, biodegradable polyanhydride, biodegradable polyester, cellulose derivatives, starch-based polymers, lignin, chitin, copolymers thereof, and combinations thereof.

9. The tool of claim 1, wherein the microbial attractant is selected from the group consisting of a sugar, starch, a furanone, and combinations thereof.

10. The tool of claim 1, wherein the biodegradability enhancement additive further includes an organic carboxylic acid.

11. The tool of claim 1, wherein the biodegradability enhancement additive comprises from about 0.5 wt % to about 5 wt % of the biodegradable polymer body.

12. The tool of claim 1, wherein the biodegradability enhancement additive is sufficient to cause at least 5% biodegradation within 15 days according to ASTM D 5511 biodegradation test under anaerobic conditions.

13. The tool of claim 1, wherein the biodegradability enhancement additive is sufficient to cause substantially complete biodegradation within 8 years according to ASTM D 5511 biodegradation test under anaerobic conditions.

14. The tool of claim 1, wherein the biodegradable polymer body is a plant identification device, comprising
a) a tag including indicia which identify a plant to which the device is associated, and wherein the tag is configured to be inserted into soil in which the plant is planted; and
b) a bioactive substance associated with the tag and capable of being dispersed into the soil.

15. An agricultural growth management tool, comprising a biodegradable polymer body which biodegrades substantially completely within 8 years according to ASTM D 5511 biodegradation test under anaerobic conditions, while also retaining fluid delivery functionality for at least 4 months and wherein the biodegradable polymer body is selected from the group consisting of agrifilm, drip tubing, drip tubing connectors, drip tubing accessories, landscape ribbon, landscape twine/rope, pot wraps, floral wraps, hanging basket assemblies, and greenhouse sheets.

16. The tool of claim 15, wherein the biodegradable polymer body is formed of a biodegradable polymer selected from the group consisting of biodegradable polyethylene, biodegradable polyanhydride, biodegradable polyester, cellulose derivatives, starch-based polymers, lignin, chitin, copolymers thereof, and combinations thereof

17. The tool of claim 15, wherein the biodegradable polymer body is formed of an inherently non-biodegradable polymer and a biodegradability enhancement additive.

18. The tool of claim 17, wherein the inherently non-biodegradable polymer is selected from the group consisting of polyethylene, polypropylene, polystyrene, polyurethane, polycarbonate, polyvinyl chloride, copolymers thereof, and combinations thereof.

19. The tool of claim 17, wherein the biodegradability enhancement additive further includes a microbial attractant selected from the group consisting of a sugar, a furanone, and combinations thereof.

20. The tool of claim 15, wherein the agricultural growth management tool is drip tubing, agrifilm, or greenhouse sheet.
